(19) United States
(12) Patent Application Publication
(10) Pub. No.: US 2026/0203753 A1
(43) Pub. Date: Jul. 16, 2026

(54) ELECTRONIC PAYMENT SYSTEM WITH TOKENIZED CUSTOMER ACCOUNT INFORMATION AND ENHANCED RETURN PROCESSING

(71) Applicant: JP Morgan Chase Bank, N.A., NEW YORK, NY (US)

(72) Inventors: Varun Pandey, Budd Lake, NJ (US); Dhruvkumar Patel, Secaucus, NJ (US); Varun Awasthi, Jersey City, NJ (US); Hanamantgouda Naganur, West Windsor, NJ (US); Santoshkumar Nayak, Edison, NJ (US); Siewyee Lai, Clifton, NJ (US); Praveen Nareddy, Carrollton, TX (US)

(73) Assignee: JP Morgan Chase Bank, N.A., NEW YORK, NY (US)

(21) Appl. No.: 19/017,019

(22) Filed: Jan. 10, 2025

(51) Int. Cl. G06Q 20/38; G06Q 20/10; G06Q 20/36; G06Q 20/40

(52) U.S. Cl. CPC G06Q 20/383; G06Q 20/108; G06Q 20/36; G06Q 20/407

(57) ABSTRACT

An originator interface is provided that is configured to present, to a given payment originator, access to a given electronic origin account. An originating system is provided that is configured to be secure and to manage the given electronic origin account to effect payments via electronic transfer. The originator interface and originating system are configured to initiate a given electronic payment to a given recipient electronic account. The originating system is further configured to cause a tokenizer secure from systems external to the secure originating system to tokenize given protected originator account information corresponding to the given electronic origin account before the given electronic payment is effected via electronic transfer, whereby a transfer system and a payment receipt system each handle the tokenized given protected originator account information to cause the electronic transfer of the given payment to the given recipient electronic account, without risk of compromise to the given protected originator account information.

### FIELD OF THE DISCLOSURE

Aspects of the present disclosure relate to electronic transfer payments. More specifically, for example, aspects of the present disclosure may relate to payment return processing. Other aspects of the disclosure may relate to preventing fraudulent electronic monetary transactions.

### BACKGROUND

Electronic payment systems generally provide an end-to-end, all-electronic transfer environment and include several securely networked systems connected via one or more intermediary systems, for example, an automated clearing house network. In real-time electronic payment systems, real-time payments, also called immediate or instant payments, are frequently completed in seconds, whereby currency (generally, fiat currency; sometimes digital currency) is both debited from a payment originator's electronic bank account and credited at a payment recipient's electronic bank account, which may be at an external or unaffiliated bank.

Some real-time electronic payment systems include the Real-Time Payments (RTP) Network, FedNow, and JPMorgan's Link Interbank Information Network (IIN). Short-term (generally, same day) payment systems include the Same Day Automated Clearing House (ACH) wire transfer system.

Digital payment solutions, such as Apple Pay, offer consumers the ability to make real-time payments for merchandise without a physical payment card or cash. As digital payment solutions increase in popularity, the use of instant payments grows. Meanwhile, the volume of unwanted and fraudulent transactions involving instant payments and wire transfers is substantial and may be increasing.

Because of, or in spite of, these risks, existing electronic payment systems may be configured in undesirable ways. For example, on the one hand, existing payment return processes require that an originating institution share originating routing and account numbers to an external merchant system or financial institution-which can lead to fraudulent or otherwise undesired activity. On the other hand, regulations are restrictive with respect to returns. For example, an ACH reversal must be initiated within five banking days of the original transaction. In addition, certain returns may require initiation or control by the originating or recipient financial institution.

### SUMMARY

An objective of the present disclosure is to improve the integrity of electronic payment transactions overall. Another objective is to limit systems outside of a trusted, secure originating depository institution's system from accessing an electronic payment originator account. Another objective is to provide an electronic payment system, for example, an electronic instant payment system, protected against fraudulent or otherwise unwanted money transfer transactions. A further objective is to provide such a system that prevents or reduces the volume of unwanted transactions such as some or all the following:
a) Fraudulent payments, withdrawals, and transfers;
b) Unauthorized online purchases;
c) The commission of ACH fraud and associated money withdrawals;
d) Unauthorized use of bank details for online shopping;
e) Laundering of money through one's bank account;
f) The creation and use of fraudulent checks;
g) Theft of identity;
h) Unauthorized access to online banking information; and
i) Tax fraud.

One or more alternate or additional objectives may be served by the present disclosure, for example, as may be apparent in the following description. Embodiments of the disclosure include any apparatus, machine, system, method, articles (e.g., computer-readable media encoded to cause certain acts), or any one or more sub-parts or sub-combinations of such apparatus (singular or plural), system, method, or article (or encoding thereon or therein), for example, as supported by the present disclosure. Embodiments herein also contemplate that any one or more processes as described herein may be incorporated into a processing circuit.

In accordance with one or more embodiments, one or more apparatus are provided. An originator interface is provided that is configured to present, to a given payment originator, access to a given electronic origin account. An originating system is provided that is configured to be secure and to manage the given electronic origin account to effect payments via electronic transfer. The originator interface and originating system are configured to initiate a given electronic payment to a given recipient electronic account. The originating system is further configured to cause a tokenizer secure from systems external to the secure originating system to tokenize given protected originator account information corresponding to the given electronic origin account before the given electronic payment is effected via electronic transfer, whereby a transfer system and a payment receipt system each handle the tokenized given protected originator account information to cause the electronic transfer of the given payment to the given recipient electronic account, without risk of compromise to the given protected originator account information.

The originator interface and originating system may be configured to initiate an instant given electronic payment, and the originating system may be configured to cause a payment to a recipient digital wallet.

Per some embodiments, the given recipient electronic account is at an electronic recipient bank account at a receiving depository institution.

Per other embodiments, the originating system is configured to cause a de-tokenizer secure from systems external to the secure originating system to de-tokenize the given protected customer account information during return processing via electronic transfer, whereby a transfer system and a payment receipt system each handle the tokenized given protected account information to cause the electronic transfer of the given return payment to the given originator account, without risk of compromise of the given protected account information.

Per other embodiments, the originating system may be configured to cause a return request processor to (i) respond to a given return request for the given payment and to (ii) cause the given return request to be processed via the transfer system and the payment receipt system.

The originating system may further be configured to cause the return request processor to cause the given return request to be processed as part of a receiving system comprising a receiving depository institution system.

Per other embodiments, the originating system may be configured to cause the return request processor to cause the given return request to be processed as part of a digital wallet processing system.

Another exemplary embodiment includes a method. The method comprises presenting, by an originator interface, to a given payment originator, access to a given electronic origin account. The method further comprises managing, by an originating system configured to be secure, the given electronic origin account to effect payments via electronic transfer. A given electronic payment is initiated to a given recipient electronic account. In addition, a tokenizer secure from systems external to the secure originating system is caused to tokenize given protected originator account information corresponding to the given electronic origin account before the given electronic payment is effected via electronic transfer, whereby a transfer system and a payment receipt system each handle the tokenized given protected originator account information to cause the electronic transfer of the given payment to the given recipient electronic account, without risk of compromise to the given protected originator account information.

Per some embodiments, an instant given electronic payment is initiated by the originator interface and originating system. Per other embodiments, the method may further include effecting payment to a recipient digital wallet.

Per select embodiments, the given recipient electronic account is at an electronic recipient bank account at a receiving depository institution.

The method may further comprise causing a de-tokenizer secure from systems external to the secure originating system to de-tokenize the given protected customer account information during return processing via electronic transfer, whereby a transfer system and a payment receipt system each handle the tokenized given protected account information to cause the electronic transfer of the given return payment to the given originator account, without risk of compromise of the given protected account information.

The method may also further comprise causing, by the originating system, a return request processor to (i) respond to a given return request for the given payment and to (ii) cause the given return request to be processed via the transfer system and the payment receipt system.

Per some embodiments, the method comprises causing, by the originating system, the return request processor to cause the given return request to be processed as part of a receiving system comprising a receiving depository institution system. In addition, or alternatively, the method may comprise causing, by the originating system, the return request processor to cause the given return request to be processed as part of a digital wallet processing system.

Yet another exemplary embodiment includes a non-transitory computer-readable media encoded to cause presenting, by an originator interface, to a given payment originator, access to a given electronic origin account; and managing, by an originating system configured to be secure, the given electronic origin account to effect payments via electronic transfer. A given electronic payment is initiated to a given recipient electronic account, and a tokenizer, secure from systems external to the secure originating system, is caused to tokenize given protected originator account information corresponding to the given electronic origin account.

This tokenization occurs before the given electronic payment is affected via electronic transfer. A transfer system and a payment receipt system each handle the tokenized given protected originator account information. The transfer system and the payment receipt system also cause the electronic transfer of the given payment to the given recipient electronic account, without risk of compromise to the given protected originator account information.

The computer-readable media may be further encoded to cause, by the originating system, a return request processor to (i) respond to a given return request for the given payment and (ii) cause the given return request to be processed via the transfer system and the payment receipt system.

The computer-readable media may be further encoded to cause, by the originating system, the return request processor to cause the given return request to be processed as part of a receiving system comprising a receiving depository institution system.

Per select embodiments, the computer-readable media may be further encoded to cause, by the originating system, the return request processor to cause the given return request to be processed as part of a digital wallet processing system.

Additional features, modes of operations, advantages, and other aspects of various embodiments are described below with reference to the accompanying drawings. It is noted that the present disclosure is not limited to the specific example embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an embodiment of an electronic payment transaction system;

FIG. 2 is a flow diagram of an embodiment of a payment process;

FIG. 3 is a flow diagram of an embodiment of a return process;

FIG. 4 is a block diagram of return processes provided at various points in the system shown in FIG. 1;

FIG. 5 is a flow diagram of a tokenization process that may be carried out by the tokenizer shown in FIG. 1;

FIG. 6 is a flow diagram of a de-tokenization process that may be carried out by the de-tokenizer shown in FIG. 1; and

FIG. 7 is a schematic diagram of a computer controller 400 that may be an application-specific hardware, software, and firmware (e.g., application specific integrated circuit (ASIC)) implementation of one or more parts of the electronic payment transaction system 10 in FIG. 1.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

In the following, reference is made to example embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim.

In accordance with one or more embodiments herein, various terms may be defined as follows.

Application or application program: An application program is a program that, when executed, performs a task for another program or user, whereas an operating system program, when executed, serves as an interface between an application program and the underlying hardware of a computer. Any one or more of the various acts described below may be carried out by a program, e.g., an application program and/or operating system program.

Processing circuit: A processing circuit (or circuit) may include both (at least a portion of) non-transitory computer-readable media carrying functional encoded data and components of an operable computer. The operable computer is capable of executing (or is already executing) the functionally encoded data and thereby is configured when operable to cause certain acts to occur. A processing circuit may also include: a machine or part of a machine that is specially configured to carry out a process, for example, any process described herein; or a special purpose computer or a part of a special purpose computer.

A processing circuit may also be in the form of a general-purpose computer running a compiled, interpretable, or compilable program (or part of such a program) that is combined with hardware carrying out a process or a set of processes. A processing circuit may further be implemented in the form of an ASIC, part of an ASIC, or a group of ASICs. A processing circuit may further include an electronic circuit or part of an electronic circuit. A processing circuit does not exist in the form of code per se, software per se, instructions per se, mental thoughts alone, or processes that are carried out manually by a person without any involvement of a machine.

Program: A program includes software for a processing circuit.

Secure or trusted system: A device, server, or application with secure environmental protections, for example, authentication, encryption, a firewall, prescribed circumstances for operation or access, and so on.

Tokenization (data security tokenization): A sensitive data element is replaced with another non-sensitive or less sensitive reference item (surrogate value), called a token. A de-tokenization system can be used to perform a mapping process to determine the token's associated sensitive data element.

User interface tools; user interface elements; output user interface; input user interface; input/output user interface; and graphical user interface tools. User interface tools are human user interface elements that allow human user and machine interaction, whereby a machine communicates to a human (output user interface tools), a human inputs data, a command, or a signal to a machine (input user interface tools), or a machine communicates, to a human, information indicating what the human may input, and the human inputs to the machine (input/output user interface tools).

Graphical user interface tools (graphical tools) include graphical input user interface tools (graphical input tools), graphical output user interface tools (graphical output tools), and/or graphical input/output user interface tools (graphical input/output tools). A graphical input tool is a portion of a graphical screen device (e.g., a display and circuitry driving the display) configured to, via an on-screen interface (e.g., with a touchscreen sensor, with keys of a keypad, a keyboard, etc., and/or with a screen pointer element controllable with a mouse, toggle, or wheel), visually communicate to a user data to be input and to visually and interactively communicate to the user the device's receipt of the input data.

A graphical output tool is a portion of a device configured to, via an on-screen interface, visually communicate to a user information output by a device or application. A graphical input/output tool acts as both a graphical input tool and a graphical output tool. A graphical input and/or output tool may include, for example, screen-displayed icons, buttons, forms, or fields. Each time a user interfaces with a device, program, or system in the present disclosure, the interaction may involve any version of a user interface tool as described above, e.g., which may be a graphical user interface tool.

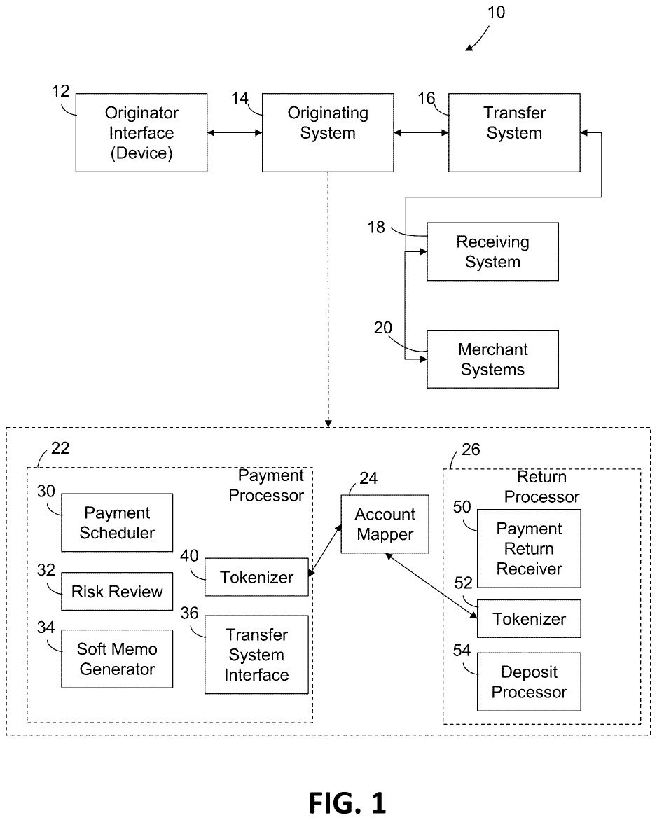

Referring to the drawings, FIG. 1 shows a block diagram of one embodiment of an electronic payment transaction system 10. The illustrated payment transaction system 10 includes an originator interface 12, an originating system 14, a transfer system 16, and a payment receipt system which may comprise merchant systems 20 and/or one or more receiving systems 18.

In the illustrated embodiment, originator interface 12 is a bank customer interface provided on a customer device. The device may comprise, for example, a smartphone, a personal digital assistant (PDA), a tablet, a personal computer, a terminal device, or some type of customer premises equipment. Per one embodiment, the interface presented to a customer may utilize a browser application providing a hypertext transfer protocol secure (HTTPS) connection via a wired or wireless network connection (e.g., the Internet) to originating system 14 configured to provide the interface from a server perspective. The connection between a device implementing originator interface 12 and originating system 14 and other connections shown in the payment transaction system 10 will preferably be a secure connection. Connections can be wired or wireless, and connection-oriented or connectionless. Generally, it is expected that layered communication will be employed, and the collective systems may alternatively be connected via virtual private network (VPN) connections.

As shown, originator interface 12, which may be in the form of a device, is able to communicate with originating system 14, while originating system 14 is able to communicate with transfer system 16. Transfer system 16 may communicate with merchant systems 20 and receiving system 18. All the entities in the illustrated payment transaction system 10 may be connected together via the Internet, or another type of network, and may be configured to communicate with each other.

Originating system 14 may comprise an originating depository institution (ODI) system. Transfer system 16 is generally an electronic payment facilitating network, that is, a clearing house. Transfer system 16 is a network for sending electronic credit and debit transfers through financial institutions, and may be nationwide throughout the United States, or international, for example, in the case of a hybrid system including a digital currency system such as JPMorgan's IIN.

Transfer system 16 may comprise an ACH clearing house network, or the clearinghouse (TCH) network, a private-sector automated clearing house and wire operator for the United States. In the illustrated embodiments, transfer system 16 may be configured to carry out ACH, TCH, or comparable operator functions. For example, transfer system 16 may be configured to receive files of payments for an ODI, edit and sort the payments, deliver payments to receiving depository institutions (RDIs), for example, receiving system 18, and settle (reconcile) payments by crediting and debiting the originating and receiving depository institutions'settlement accounts.

Merchant systems 20 generally include merchant payment-related systems for processing payments and returns from and to customers, for example, related to purchases of goods or services. Receiving system 18, in the illustrated embodiment, is a system of a receiving depository institution.

In the illustrated embodiments, originating system 14 and receiving system 18 comprise secure systems or networks of financial institutions, each configured for performing automated depository-related functions and provisioning, activating, and supporting electronic bank accounts, meaning the accounts are configured for sending and receiving electronic transfer payments. For example, an account may be configured for sending and receiving money according to the RTP Network, the FedNow real-time system, Same Day ACH, IIN, another hybrid blockchain and digital currency-based interbank network, and/or a digital wallet transfer technology.

The illustrated originating system 14 may include, among other things, the payment processor 22, return processor 26, and account mapper 24 as shown. Payment processor 22 is configured to carry out processing related to payments generally from an originator account at originating system 14 to a recipient account at receiving system 18. Return processor 26 is configured to carry out return processing. For example, return processor 26 may be configured to respond to a given return request for a given payment, and cause the given return request to be processed.

Payment processor 22 includes a payment scheduler 30 for scheduling initiated payments, a risk review processor 32 for managing risk review processes pertaining to a given transaction, and a soft memo generator 34 for preparing a soft memo associated with a given transaction before sending the transaction to transfer system 16 for electronically carrying out the payment, among other things.

Payment processor 22 further includes a transfer system interface 36 for communicating and interacting with transfer system 16, and a tokenizer 40. Tokenizer 40 is configured to process, i.e., tokenize, origin account information in a manner associated with a transaction, which is an electronic payment to a merchant or to a receiving electronic account at receiving system 18. In this process, a token or surrogate is produced for each protected originator account information entity. Per one embodiment, an originator account information entity includes an originating bank routing number and a payment originator's account number at the originating bank (of an electronic account, in the illustrated embodiments).

In some embodiments, the sensitive data element to be tokenized may be encoded account information that serves as an intermediate data entity that in and of itself does not fully identify the actual bank account. For example, an intermediate data entity could include the name of the payment originator and the last four digits of a taxpayer identification such as a social security number. Other embodiments include the sensitive data element identifying the payment originator source account with a card number and associated information (e.g., a debit card, expiration date, security code, and/or chip data) or with a customer digital wallet account identifier.

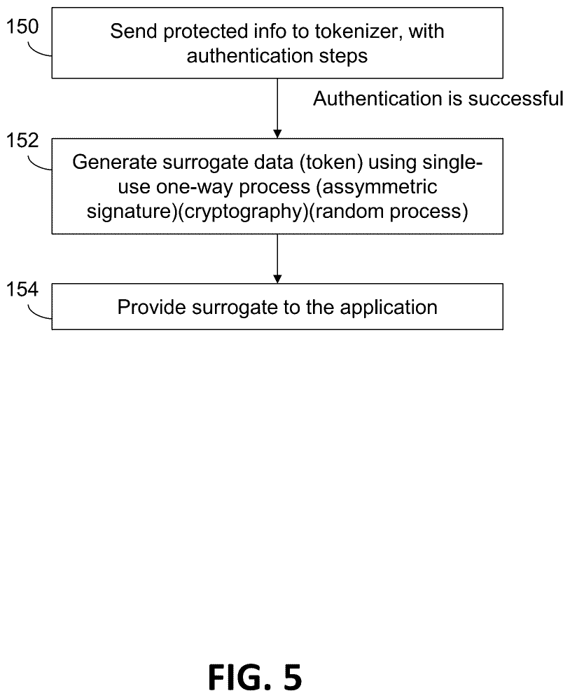

Tokenizer 40 is in communication with an account mapper 24, which is secure to originating system 14 (in the illustrated embodiment, account mapper 24 is part of originating system 14). Tokenizer 40 forwards information pertaining to each transaction, the tokenized sensitive data element, and information tracking or associating the unaffected sensitive data element with a unique token (surrogate). This process is discussed further herein, for example, below in connection with the tokenization process shown in FIG. 5.

Return processor 26 in the illustrated payment transaction system 10 includes, among other things, a payment return receiver 50, a de-tokenizer 52, and a deposit processor 54. Payment return receiver 50 is provided to receive, from an external system such as an external financial institution controlled receiving system 18, a return transaction accompanied by information identifying the account to which the return should be paid. In the illustrated embodiment, this is in the form of the surrogate for the protected originator account information. Return processor 26 is configured to cause de-tokenizer 52 to interact with account mapper 24 to ascertain the protected originator account information. In some embodiments, de-tokenizer 52 may be configured to obtain, with the interaction with account mapper 24, other information sufficient to allow a return payment to be affected or accessible by the originator account (for example, via an intermediate digital wallet or digital currency account). Deposit processor 54 is configured to facilitate the return payment to the payment originator account, or the intermediate account in alternate embodiments.

In operation, originator interface 12 presents to a given payment originator access to a given electronic origin account, for example, prompting the payment originator with input options, including payment instruction inputs. Originating system 14 manages the given electronic origin account, which is configured for electronic transfers, and affects payments via electronic transfer. Transfer system 16 receives files of payments, including a given payment, from the given originator's electronic account. Transfer system 16 further edits and sorts payments, delivers the payments, and settles the payments at the originating and receiving accounts. A payment receipt system, that is, merchant systems 20 and/or receiving system 18 (and/or one or more intermediary systems, such as a blockchain digital currency system, a digital wallet system, etc.), receives payments including the given patent. This may include making one or more deposits into one or more electronic recipient accounts, for example, at one or more receiving depository institutions.

As described below, a return request processor may be provided. In select embodiments, this return request processor is provided as part of the receiving system, as part of a receiving depository institution, or as part of a digital wallet processing system. The return request processor may be configured to respond to a given return request for the given payment and to cause the given return request to be processed via transfer system 16 and the payment receipt system.

Tokenizer 40 is shown in FIG. 1 as part of originating system 14. In other embodiments, tokenizer 40 may be provided as part of another system securely controlled by originating system 14. For example, tokenizer 40 and any associated processing circuits including account mapper 24 and de-tokenizer 52, may be provided as part of originating system 14 or part of an external system, yet containerized and protected from other parties. Further, tokenizer 40 may be configured for secure exclusive access to and control by originating system 14.

More specifically, tokenizer 40 may be configured to tokenize the protected originator account information before a given payment is impacted via electronic transfer, whereby transfer system 16 and a payment receipt system (e.g., merchant systems 20 and/or receiving system 18) each handle the given tokenized protected account information to cause the electronic transfer of the given payment to a receiving account, without risk of compromise to the given protected account information.

When a return is processed, de-tokenizer 52 may be configured to de-tokenize the protected customer account information, whereby transfer system 16 and a payment receipt system (e.g., receiving system 18) each handle the tokenized given protected account information to cause the electronic transfer of the given return payment to the given originator account, without risk of compromise of the given protected account information.

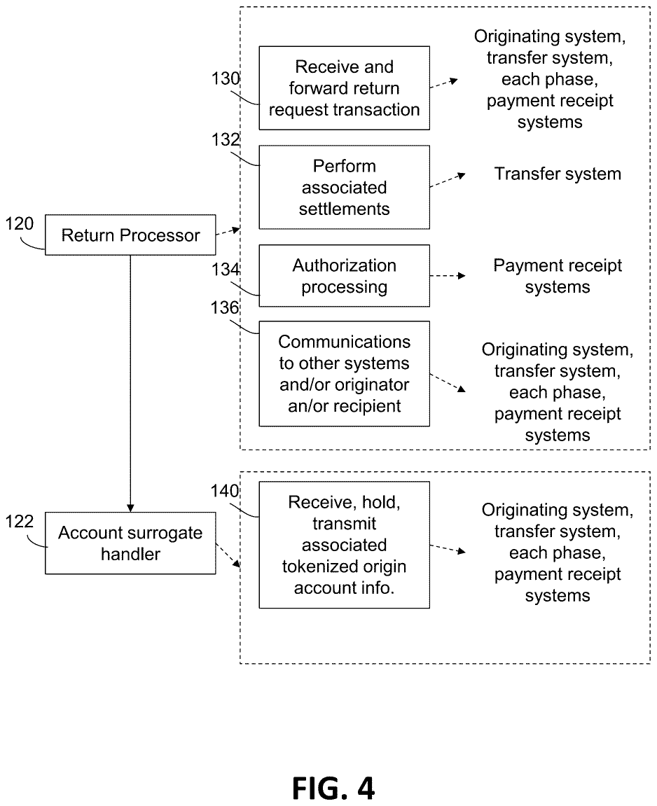

FIG. 4 shows a block diagram of return-related processes that may be provided at various points within the payment transaction system 10 shown in FIG. 1. A return processor 120 and an account surrogate handler 122 are provided.

Return processor 120 may include one or more of the following: code or a processing circuit 130 configured to receive and forward a return request transaction; code or a processing circuit 132 configured to perform associated settlements of a given return transaction; code or a processing circuit 134 configured to perform authorization processing whereby the return is authorized and allowed or disallowed to proceed; and code or a processing circuit 136 configured to cause communications to other systems and/or to a payment originator and/or to a payment recipient.

Surrogate handler 122 may include code or a processing circuit 140 configured to receive, hold, and transmit associated tokenized electronic origin account information pertaining to a given return request.

Per some embodiments, code or processing circuit 130 may be part of originating system 14, transfer system 16, and each phase of payment receiving and merchant systems 18, 20. Code or processing circuit 132 may be part of transfer system 16, including any digital currency transfer portions (if applicable). Code or processing circuit 134 may be part of one of the payment receiving and merchant systems 18, 20. Code or processing circuits 136 and 140 may each be part of originating system 14, transfer system 16, and payment receiving and merchant systems 18, 20.

Each of these instances of return processing circuits or processes may be implemented as a partial process. The originator's electronic account may be configured for electronic transfer. More specifically, the account may be configured for real-time payments and/or for a short-term wire transfer.

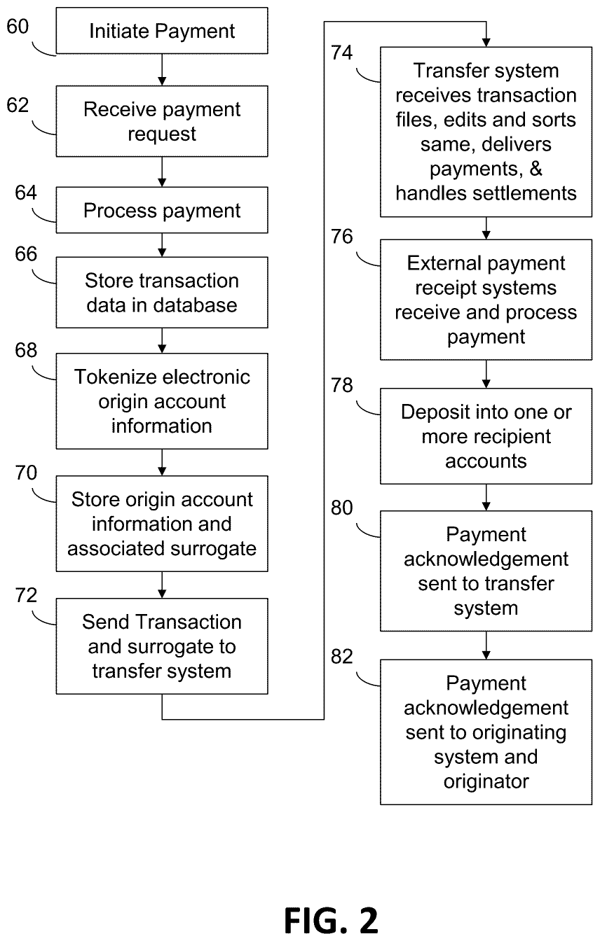

FIG. 2 is a flow chart of a payment process that may be carried out by the electronic payment transaction system 10 shown in FIG. 1. At an early step 60, a payment is initiated. This initiation of a payment may occur at one or both of payment originator interface 12 and originating system 14. Per one embodiment, a customer interacts with payment originator interface 12 and provides payment instructions via an interface provided on a browser.

Once the payment is initiated at step 60, steps 62, 64, 66, 68, 70, and 72 are performed at originating system 14. At step 62, the originating system 14 receives the payment request. At step 64, originating system 14 processes the payment. This processing may include scheduling via payment scheduler 30, a risk review via risk review processor 32, and generation of a soft memo via soft memo generator 34.

At step 66, the transaction data is stored in a database, and further associated with account mapper 24. In one embodiment, account mapper 24 includes a separate additional database for holding encrypted mapping data associating transaction data with protected information and corresponding surrogates. At step 68, the electronic origin account information is tokenized. This step may involve use of tokenizer 40 as shown in FIG. 1.

At step 70, the origin account information and associated surrogate/token are stored. In this step, this information is stored using account mapper 24, and the information for the transaction is kept encrypted.

At step 72, the transaction information and associated electronic origin account surrogate information are sent to transfer system 16, for example, via transfer system interface 36. At step 74, transfer system 16 receives transaction files including the information sent at step 72. It then edits and sorts the files, delivers payments, and handles settlements at the appropriate points in the process.

At step 76, the external payment receiving and merchant systems 18, 20 receive and process the payment. Then, at 78, a deposit is made into one or more electronic recipient accounts. This step may be done at one or more receiving depository institutions and/or merchant systems.

At step 80, any applicable receiving and merchant systems 18 and 20 sends a payment acknowledgment to transfer system 16 pertaining to the transaction.

At step 82, the transfer system 16 sends a payment acknowledgment to originating system 14 and to the originator via originator interface 12.

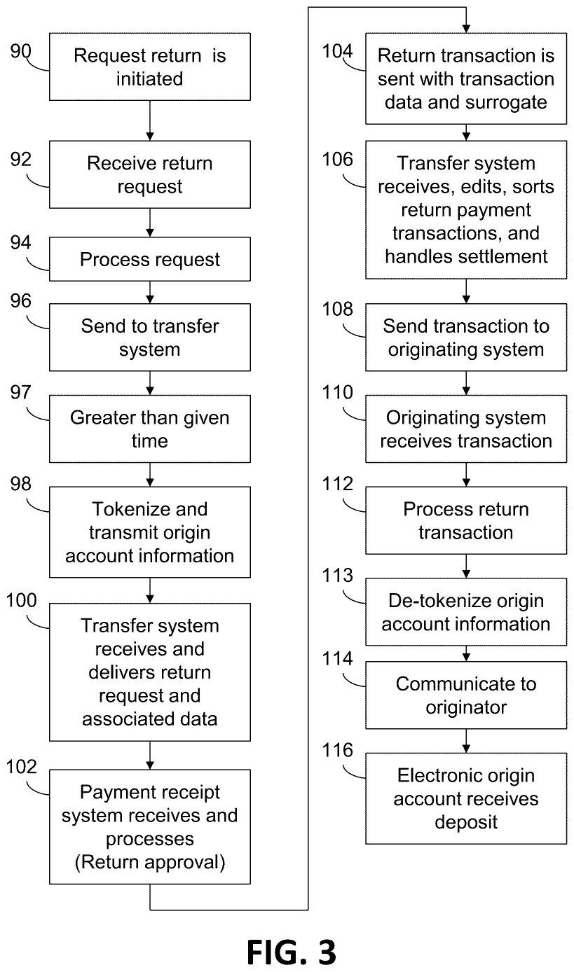

FIG. 3 is a flow chart of a return process that may be carried out by the electronic payment transaction system 10 shown in FIG. 1.

At an early step 90, a return request is initiated. In the illustrated embodiment, this request initiation is made by the payment originator, via originator interface 12. Per other embodiments, a return may be initiated by another party, for example, from a merchant system 20 or from a receiving system 18.

Steps 92, 94, and 96 are then performed at originating system 14. Specifically, at step 92, a return request is received, which identifies, among other things, the transaction and the original payment originator and payment recipient information. At step 94, the return request is processed. This includes at least formulating a return request transaction. At step 96, the return request transaction is forwarded to transfer system 16.

An optional step 97 includes determining if a certain amount of time has passed, by which transfer system 16 and receiving system 18 may not be able to identify the transaction with tokenized account information. The amount of time, for example, may be over five bank days. Then at step 98, per another optional step, the origin account is tokenized and the return transaction is sent to transfer system 16 along with the surrogate for the origin account, which will become the return destination account. In one embodiment steps 97 and 98 are performed at originating system 14.

At step 100, transfer system 16 receives and delivers the return request and associated data to the applicable payment receiving system 18 or 20. Then, steps 102 and 104 are performed at receiving and merchant systems 18, 20. At step 102, the payment receiving and merchant systems 18, 20 receive and process the return request. This step may include a return approval confirmation process, by which a given receiving organization or entity or system may either approve or reject the requested return. At step 104, the return transaction is sent from the applicable payment receiving and merchant systems 18, 20 to transfer system 16 with associated transaction data and an origin account surrogate.

At step 106, transfer system 16 receives, edits, and sorts return payment transactions and performs associated settlement activities. At step 108, and performed at transfer system 16, transfer system 16 sends the return payment transaction to the originating system 14.

At this point, the following steps are performed at originating system 14. At step 110, originating system 14 receives the return transaction. At step 112, the return transaction is processed. Then, at step 113, the origin account information is de-tokenized and re-associated with the return transaction. At step 114, the return is communicated to the originator, for example, through an online notification or via an email. At step 116, the deposit is made into the payment origin account.

FIG. 5 is a flow diagram of a tokenization process that may be performed by the payment transaction system 10 illustrated in FIG. 1. At step 150, the application (part of originating system 14) send protected information to the tokenizer 40, with authentication-related steps and information required to authenticate that an authorized process is requesting access to the tokenization process. If the authentication is successful, the process proceeds to step 152, at which point, the surrogate data (token) is generated using a single-use one-way process. Depending on the embodiment, this may involve asymmetric signature, cryptography, and/or a random process. At step 154, tokenizer 40 provides the surrogate to the application.

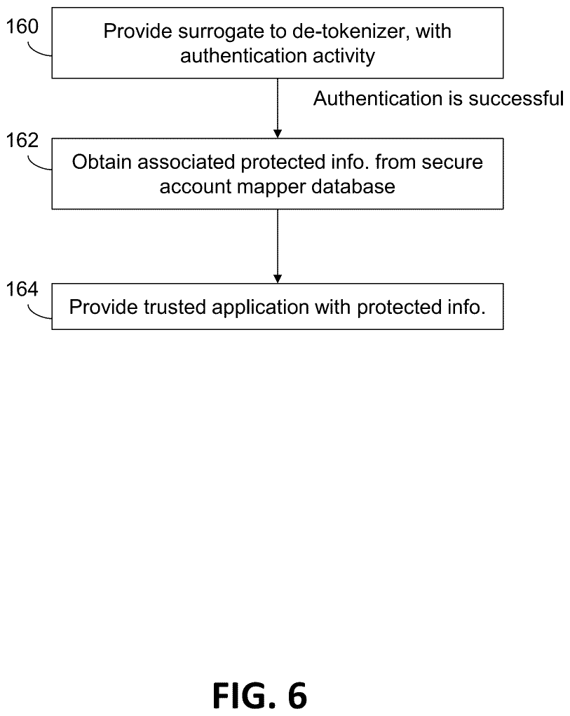

FIG. 6 is a flow diagram of a de-tokenization process that may be performed by the payment transaction system 10 illustrated in FIG. 1. At step 160, a surrogate is provided to the de-tokenizer, with certain authentication information and activity. If the authentication is successful, the process proceeds to step 162, where the application obtains transaction-associated protected information from the secure account mapper database (account mapper 24 in FIG. 1). Then, at step 164, the trusted application within originating system 14 is provided with the protected account information.

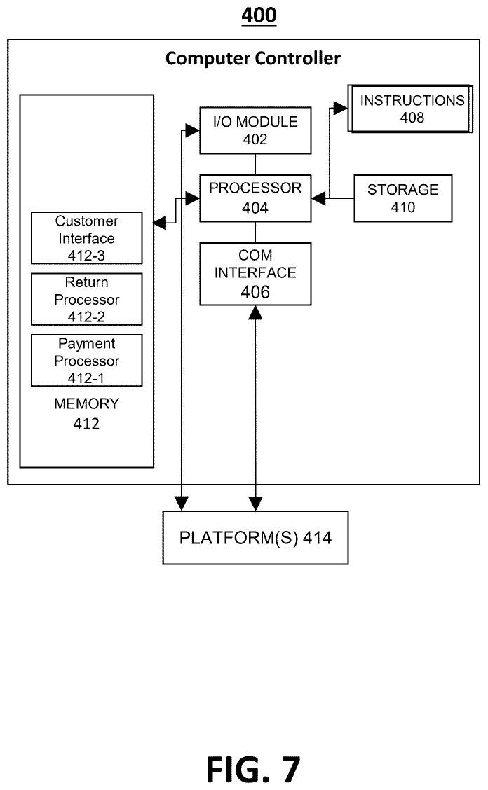

FIG. 7 illustrates a computer controller 400 that may be an application-specific hardware, software, and firmware implementation of one or more parts of the electronic payment transaction system 10 in FIG. 1, described above. The c above.

The processor 404 can have a specific structure imparted to the processor 404 by instructions stored in the memory 412 and/or by instructions 408 fetchable by the processor 404 from a storage medium 410. The storage medium 410 can be remote and communicatively coupled to the controller 400.

The controller 400 can be a stand-alone programmable system, or a programmable module included in a larger system. For example, the controller 400 may include or be connected with the originating system 14. For example, the controller 400 may include one or more hardware and/or software components configured to fetch, decode, execute, store, analyze, distribute, evaluate, and/or categorize information.

The processor 404 may include one or more processing devices or cores (not shown). In some embodiments, the processor 404 may be a plurality of processors, each having one or more cores. The processor 404, in another embodiment, may be a distributed processor. The processor 404 can execute instructions fetched from the memory 412, i.e., with reference to, among other code, instructions or data, one of memory modules 412-1, 412-2, or 412-3. Alternatively, the instructions can be fetched from the storage medium 410, or from a remote device connected to the controller 400 via the communication interface 406. Furthermore, the communication interface 406 can also interface with computer systems within a computer system of the payment transaction system 10. An input/output (I/O) module 402 may be configured for additional communications to or from associated local and/or remote systems of one or more platforms 414 of payment transaction system 10.

Without loss of generality, the storage medium 410 and/or the memory 412 can include a volatile or non-volatile, magnetic, semiconductor, tape, optical, removable, non-removable, read-only, random-access, or any type of non-transitory computer-readable computer medium. The storage medium 410 and/or the memory 412 may include programs and/or other information usable by processor 404. Furthermore, the storage medium 410 can be configured to log data processed, recorded, or collected during the operation of controller 400.

The data may be time-stamped, location-stamped, cataloged, indexed, encrypted, and/or organized in a variety of ways consistent with data storage practice. The memory modules in memory 412 may represent specialized modules for various functions described in the embodiments herein. By way of example, the memory module 412-1 may represent a specialized module configured to implement one or more aspects of payment processor 22 described above. Similarly, the memory module 412-2 may form a return processor 26 as described above with reference to FIG. 1, and the memory module 412-3 may form a specialized server-side customer interface for interfacing with originator interface 12 as described above with reference to FIG. 1. The instructions embodied in these memory modules can cause the processor 404 to perform certain operations consistent with the functions described above.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

While the foregoing is directed to embodiments of the present disclosure, other and further embodiments of the disclosure may be devised without departing from the basic scope thereof, and the scope thereof is determined by the claims that follow.

1. The apparatus comprising:
an originator interface configured to present, to a payment originator, access to a electronic origin account; and
an originating system configured to be secure and to manage the electronic origin account to effect payments via electronic transfer;
wherein the originator interface and originating system are configured to initiate a electronic payment to a recipient electronic account; and
wherein the originating system is further configured to cause a tokenizer secure from systems external to the secure originating system to tokenize protected originator account information corresponding to the electronic origin account before the electronic payment is effected via electronic transfer, whereby a transfer system and a payment receipt system each handle the tokenized protected originator account information to cause the electronic transfer of the payment to the recipient electronic account, without risk of compromise to the protected originator account information wherein the originator interface and the originating system are configured to initiate an instant electronic payment and wherein the originating system is configured to cause a de-tokenizer secure from systems external to the secure originating system to de-tokenize the protected originator account information during return processing via electronic transfer, whereby a transfer system and a payment receipt system each handle the tokenized protected account information to cause the electronic transfer of the return payment to the originator account, without risk of compromise of the protected originator account information.

2. (canceled)

3. The apparatus according to claim 1, wherein the originating system is configured to cause a payment to a recipient digital wallet.

4. The apparatus according to claim 1, wherein the recipient electronic account is at an electronic recipient bank account at a receiving depository institution.

5. (canceled)

6. The apparatus according to claim 1, wherein the originating system is configured to cause a return request processor to (i) respond to a return request for the payment and to (ii) cause the return request to be processed via the transfer system and the payment receipt system.

7. The apparatus according to claim 1, wherein the originating system is configured to cause the return request processor to cause the return request to be processed as part of a receiving system comprising a receiving depository institution system.

8. The apparatus according to claim 7, wherein the originating system is configured to cause the return request processor to cause the return request to be processed as part of a digital wallet processing system.

9. A method comprising:
presenting, by an originator interface, to a payment originator, access to a electronic origin account; and
managing, by an originating system configured to be secure, the electronic origin account to effect payments via electronic transfer;
wherein a electronic payment is initiated to a recipient electronic account; and
wherein a tokenizer secure from systems external to the secure originating system is caused to tokenize protected originator account information corresponding to the electronic origin account before the electronic payment is effected via electronic transfer, whereby a transfer system and a payment receipt system each handle the tokenized protected originator account information to cause the electronic transfer of the payment to the given recipient electronic account, without risk of compromise to the protected originator account information, wherein an instant electronic payment is initiated by the originator interface and originating system and wherein a de-tokenizer secure from systems external to the secure originating system is caused to de-tokenize the protected originator account information during return processing via electronic transfer, whereby a transfer system and a payment receipt system each handle the tokenized protected originator account information to cause the electronic transfer of the return payment to the originator account, without risk of compromise of the protected originator account information.

10. (canceled)

11. The method according to claim 9, wherein a payment is effected to a recipient digital wallet.

12. The method according to claim 9, wherein the recipient electronic account is at an electronic recipient bank account at a receiving depository institution.

13. (canceled)

14. The method according to claim 9, comprising causing, by the originating system, a return request processor to (i) respond to a return request for the payment and to (ii) cause the return request to be processed via the transfer system and the payment receipt system.

15. The method according to claim 14, comprising causing, by the originating system, the return request processor to cause the return request to be processed as part of a receiving system comprising a receiving depository institution system.

16. The method according to claim 14, comprising causing, by the originating system, the return request processor to cause the return request to be processed as part of a digital wallet processing system.

17. A non-transitory computer readable storage medium, encoded to cause:
presenting, by an originator interface, to a payment originator, access to a given electronic origin account; and
managing, by an originating system configured to be secure, the electronic origin account to effect payments via electronic transfer;
wherein a electronic payment is initiated to a recipient electronic account; and
wherein a tokenizer secure from systems external to the secure originating system is caused to tokenize given protected originator account information corresponding to the electronic origin account before the electronic payment is effected via electronic transfer, whereby a transfer system and a payment receipt system each handle the tokenized given-protected originator account information to cause the electronic transfer of the payment to the recipient electronic account, without risk of compromise to the protected originator account information;
wherein an instant electronic payment is initiated by the originator interface and originating system; and
wherein a de-tokenizer secure from systems external to the secure originating system is caused to de-tokenize the protected originator account information during return processing via electronic transfer, the protected originator account information including an originating bank routing number and a payment originator's account number at the originating system, whereby a transfer system and a payment receipt system each handle the tokenized protected account information to cause the electronic transfer of the return payment to the protected originator account, without risk of compromise of the protected originator account information.

18. The computer readable storage medium according to claim 17, further encoded to cause, by the originating system, a return request processor to (i) respond to a return request for the payment and to (ii) cause the return request to be processed via the transfer system and the payment receipt system.

19. The computer readable storage medium according to claim 18, further encoded to cause, by the originating system, the return request processor to cause the return request to be processed as part of a receiving system comprising a receiving depository institution system.

20. The computer readable storage medium according to claim 18, further encoded to cause, by the originating system, the return request processor to cause the return request to be processed as part of a digital wallet processing system.
